(19) United States
(12) Patent Application Publication
(10) Pub. No.: US 2011/0005422 A1
(43) Pub. Date: Jan. 13, 2011

(54) Method and Apparatus for Cooling a Planet

(75) Inventor: Stephen Trimberger, San Jose, CA (US)

Correspondence Address: Stephen Trimberger, 1261 Chateau Dr, San Jose, CA, 95120, US

(73) Assignee: Stephen Trimberger, San Jose, CA (US)

(21) Appl. No.: 12/501,445

(22) Filed: Jul. 12, 2009

(51) Int. Cl. F42D 3/00; F42D 1/05; G21J 1/00

(52) U.S. Cl. 102/301; 102/215; 376/914

(57) ABSTRACT

A method and apparatus for cooling a planet uses an explosion to lift a dust cloud into the atmosphere. The dust cloud shields the surface of the planet from some sunlight. One aspect of the invention relates to detonating an explosive to generate a dust cloud and to create an updraft to lift the dust cloud into the atmosphere where it can be spread by winds over the area to be cooled. The dust in the atmosphere blocks sunlight from reaching the surface, allowing the planet to cool. Multiple explosions at multiple locations or at the same location may be use for greater cooling. Explosions may be caused by nuclear weapons or by the impact of an asteroid or comet.

### FIELD OF THE INVENTION

One or more aspects of the present invention relate generally to cooling a planet and, more particularly, to a method and apparatus for reducing the amount of heat received by the surface of the planet Earth from the sun.

### BACKGROUND

The planet Earth is warming. There are many potential causes of the warming, including normal multi-year fluctuations in temperature, increased solar output, and increased greenhouse gasses in the atmosphere as a result of human activity. The increased global temperature may be responsible for loss of arable farmland to desertification, increases in the number and strength of hurricanes and other storms, species extinction, loss of polar ice caps and rising sea levels. These undesirable effects may lead to great loss of life and property. Methods for dealing with global warming, such as curbing greenhouse gas emissions, have been criticized as being economically unattractive. Other methods, such as sequestering carbon dioxide from the atmosphere, may be slow to take effect. Still others, such at launching large sun-shades into space, rely on a large number of rocket launches, that themselves may release additional carbon dioxide into the atmosphere.

While some areas, such as deserts, may face problems from warming, other areas, such as polar regions, may benefit from warming. A preferred method for dealing with global warming would be geographically selective. Cooling may be preferred in summer rather than in winter. A preferred method for dealing with global warming would be seasonally selective.

Accordingly, there exists a need for a method to cool the planet in order to stop the undesirable effects of global warming. Because of the uncertainty over the underlying cause of the warming, a method of cooling the planet should be adjustable to changing conditions. Ideally, the cooling method should be adjustable to compensate for normal variations in temperature and climate. It should also be geographically adjustable to target cooling to critical areas, such as growing deserts or shrinking ice caps. The cooling method should work quickly and should not release additional greenhouse gasses into the atmosphere, which might exacerbate the warming problem. The method should be economically feasible.

### SUMMARY OF THE INVENTION

One aspect of the invention relates to increasing the amount of particulate matter in the upper atmosphere in order to prevent some solar radiation from reaching the surface of the planet, thereby cooling the planet or a region of the planet. Another aspect of the invention relates to scheduling and adjusting the injection of particles into the atmosphere in order to control the timing and amount of cooling.

An apparatus for cooling a planet comprises a source site and a first explosive located at the source site for generating a dust cloud and for generating an updraft to lift the dust cloud so that it persists in the atmosphere and blocks sunlight from reaching the planet. In some embodiments, an apparatus for cooling a planet further comprises a decision system and a measurement device.

A method for cooling a planet comprises selecting a source site, generating a dust cloud and generating an updraft at the source site. In some embodiments, the step of generating a dust cloud and generating an updraft comprise an explosion. In some embodiments, each comprises a separate action, which may be an explosion. Explosions may be caused by a nuclear explosive or by the impact of an asteroid or comet.

In some embodiments, an explosion lifts dust into the atmosphere and simultaneously creates a strong updraft that carries the dust into the upper atmosphere. Prevailing high-altitude winds spread dust the atmosphere to cover that part of the planet which is intended to be cooled. The amount of cooling is measured and the sequence may be repeated until the desired cooling is achieved. The explosion may be a nuclear explosion or may be caused by the impact of an asteroid.

### BRIEF DESCRIPTION OF THE DRAWINGS

The accompanying drawings show exemplary embodiments in accordance with one or more aspects of the invention. However, the accompanying drawings should not be taken to limit the invention to the embodiments shown, but are for explanation and understanding only.

FIG. 1 is an elevation view depicting one embodiment showing the placement of a nuclear explosive below ground level;

FIG. 2 is an elevation view depicting another embodiment showing the placement of a nuclear explosive above ground level;

FIG. 3 is an elevation view illustrating an updraft and rising dust cloud and their interaction with high-altitude winds;

FIG. 4A is an elevation view depicting an embodiment of the invention showing the placement of a second nuclear explosive to increase the altitude of the dust lifted into the atmosphere;

FIG. 4B is an elevation view illustrating an enhanced updraft produced by the second explosive;

FIG. 5 illustrates air circulation patterns around Earth;

FIG. 6A depicts the orbits of Earth and an exemplary asteroid and their point of intersection;

FIG. 6B depicts the line of possible impact sites for an exemplary asteroid with modifications to its orbit; and

FIG. 7 is a flowchart of a method for cooling a planet.

### DETAILED DESCRIPTION OF THE DRAWINGS

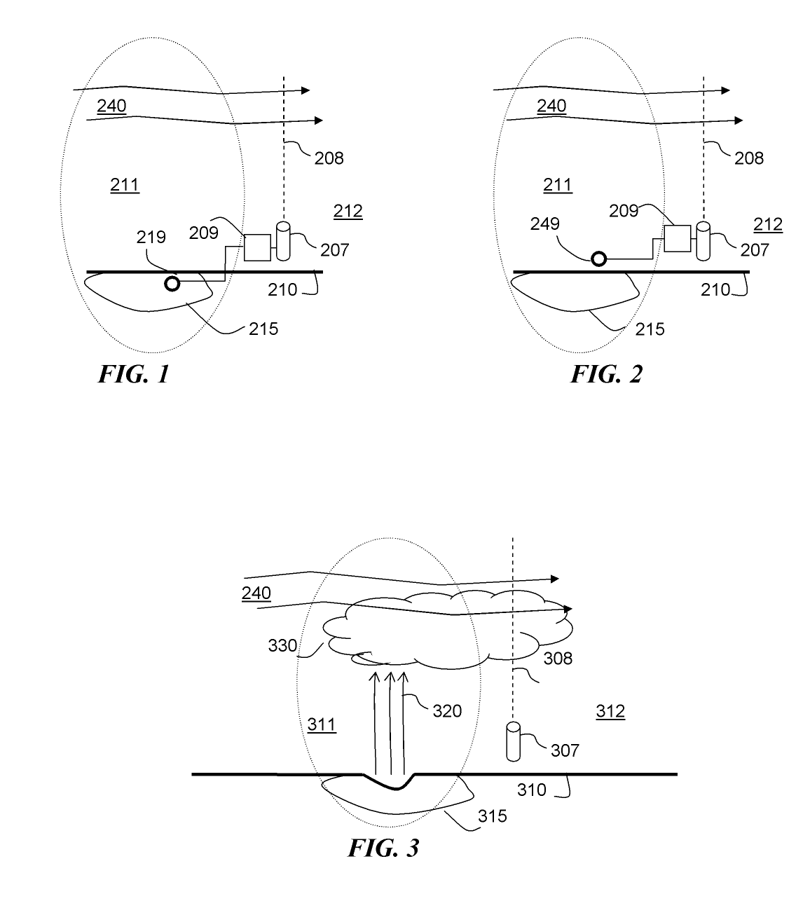

FIG. 1 depicts a placement of an explosive device 219 according to some embodiments of the invention. The explosive device is located below ground level 210 at source site 215. Locating the explosive device below ground level may enhance the amount of material, such as rock and dirt that are pulverized by the explosion forming the dust cloud. The dust cloud is described with respect to FIG. 3, below.

Source site location 215 is a geographical position on the surface of the planet, typically characterized by a latitude and longitude and source site 211 comprises the air directly above the geographical location as well as a region directly below the surface of the planet at the geographical location.

Many criteria may be applied to select source site 211. Source site location may be on land or water. It may be chosen to be removed from populated areas or valuable property in order to minimize damage from the explosion. A safe distance may be ten kilometers. The material at the surface of the planet at the source site location may be fractured rock, the fracturing being accomplished by any means, including explosives or as a result of mining operations. The source site Imay contain material that is chemically useful for reflecting or absorbing solar radiation at the wavelength produced by the sun. Source site may comprise a volcanic region where hot magma (not shown) is located underground close enough to ground level that an explosion may expose it to air or water or release trapped gasses. Source site location may be the caldera of a volcano. The source site may be chosen for the elevation of the ground surface. A source site location at a high elevation may require less updraft to lift a dust cloud into the high-altitude winds 240. The size of the source site may be chosen to contain the explosion, but may be two miles in diameter.

Source site may intersect high-altitude winds 240 that blow in the direction of the target region 212, that part of the planet that is to be cooled. High-altitude winds 240 are typically twenty thousand to forty-five thousand feet above sea level, though terrain and seasonal variation may alter their altitude, strength and direction. Target region may be the entire planet, or may be limited to a smaller geographic area.

Measurement device 207 measures solar radiation that penetrates the atmosphere. Measurement device may measure temperature or light intensity or light spectrum along a path through the atmosphere 208. Measurement device may also measure wind speed and direction. A decision system 209 receives measurement data from the measurement device 207 and may send a signal to the explosive 219. If the measurement device indicates a sufficiently high planetary temperature or a sufficiently rising planetary temperature, and high-altitude winds are blowing toward the target area 212, the decision system may initiate the explosion. The decision system may include a manual enable switch to ensure that the explosion occurs only when a human operator determines that is safe. FIG. 2A is shown not to scale for clarity in describing the invention.

FIG. 2B depicts another placement of an explosive 249, which may be a nuclear explosive or a chemical explosive. The explosive 249 is located at or slightly above ground level 210 at source site 215. The explosive may be placed on a support structure (not shown). Locating the explosive at or above ground level may enhance the strength of the updraft for lifting dust cloud into the atmosphere. As a result, the dust cloud may rise higher. The updraft and dust cloud are described with respect to FIG. 3, below.

FIG. 3 illustrates an updraft 320 and dust cloud 330. The explosion may pulverize material at source site 315 into a dust cloud 330. In some embodiments, material at source site 315 already forms a dust cloud. Heat generated by the explosion causes an updraft that lifts the dust cloud. When the dust cloud reaches high-altitude winds 240, the high-altitude winds may spread the dust cloud over the target region 312. The dust cloud may block sunlight from reaching the ground, cooling the target region. Thus, some embodiments of the invention may cool a region of a planet, rather than the entire planet. Measurement device 307 measures solar radiation that penetrates the atmosphere. Measurement may be a temperature or spectral measurement along a path through the atmosphere 308. A measurement device may measure wind speed and direction at ground level or at altitude. FIG. 3 is shown not to scale for clarity in describing the invention.

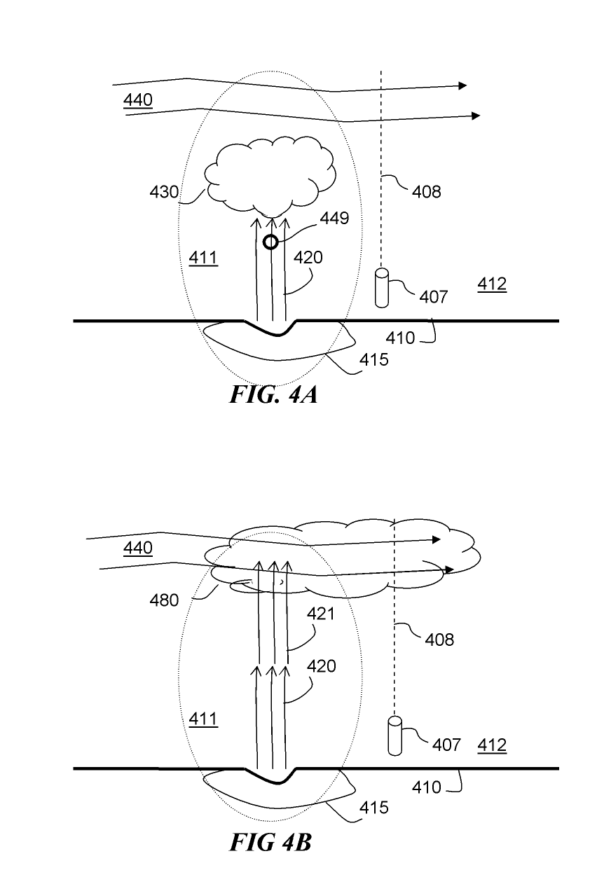

FIG. 4A depicts an embodiment of the invention showing the placement of a second nuclear explosive 449 to increase the altitude of the dust cloud lifted into the atmosphere. Second nuclear explosive 449 is placed above source site location 215. After the first explosion, updraft 420 may lift dust cloud 430 to insufficient height to reach high-altitude winds 440 that will move the dust cloud over the target region to be cooled 412. Second nuclear explosive 449 is detonated to enhance updraft. Second nuclear explosive may be delivered to vertical source site from an aircraft, on a missile or fired by artillery.

FIG. 4B illustrates the enhanced updraft produced by the second explosion. Enhanced updraft 421 may lift dust cloud 480 to reach high-altitude winds. Dust cloud may be lifted above high-altitude winds which may permit the dust cloud to persist in the atmosphere longer. Measurement device 407 measures solar radiation that penetrates the atmosphere. Measurement may be a temperature or spectral measurement along a path through the atmosphere 408. FIG. 4A and FIG. 4B are shown not to scale for clarity in describing the invention.

A determination is made to cool a planet. The determination may be based on measurements of heat at the surface of the planet. To cool a planet, a source site is selected and an explosion is caused at the source site. The explosion may be caused by an explosive device such as a nuclear explosive. The subsequent explosion pulverizes material at the source site forming a dust cloud. The explosion may also cause an updraft, due to the heat of the explosion. The dust cloud is lifted by the updraft into the atmosphere. High-altitude winds may spread the dust cloud and carry the dust cloud over a target area to be cooled.

A single explosion may both generate the dust cloud and generate the updraft that lifts the dust cloud into the high-altitude winds. In other embodiments, the explosion serves only to create the updraft. In still other embodiments, separate explosions generate the dust cloud and the updraft.

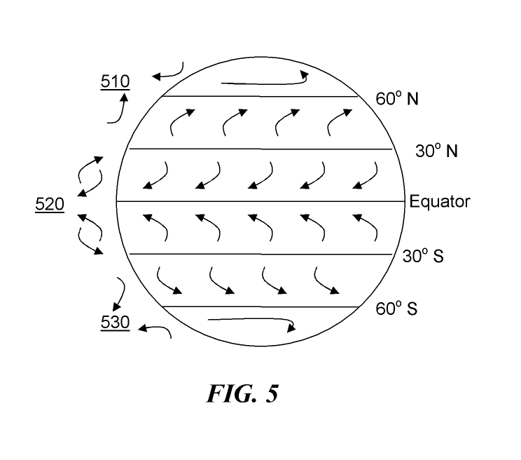

FIG. 5 illustrates air circulation patterns around Earth 501. Winds between 30 degrees North and 30 degrees South latitude blow predominately East to West and toward the equator. Between 30 degrees North and 60 degrees North, winds blow predominately West to East and toward the North. Between 30 degrees South and 60 degrees South, winds blow predominately West to East and toward the South. Between 60 degrees North and 90 degrees North, winds are dominated by the North polar circulation. Between 60 degrees South and 90 degrees South, winds are dominated by the South polar circulation. These are general circulation patterns, and the latitudes are approximate. Actual winds at ground level and at altitude vary depending on the season, storms, differential heating of air and chaotic movement of air masses. Careful selection of the source site and timing of the explosion are important considerations to ensure cooling over the target region and to avoid damage to people and property.

The Northerly and Southerly motions of air cause collisions of air masses and global air circulation patterns. Over the equator, air generally rises in a natural updraft 520. Similarly, a weaker updraft is located at 60 degrees North and 60 degrees South latitude. An explosion at these latitudes may be able to take advantage of natural air circulation patterns to disperse dust clouds and cool the planet. Further, the Eastern and Western motions of the air permit selection of a source site some distance away from the target region to be cooled, which may reduce the risk to people and property in the target region from the explosion.

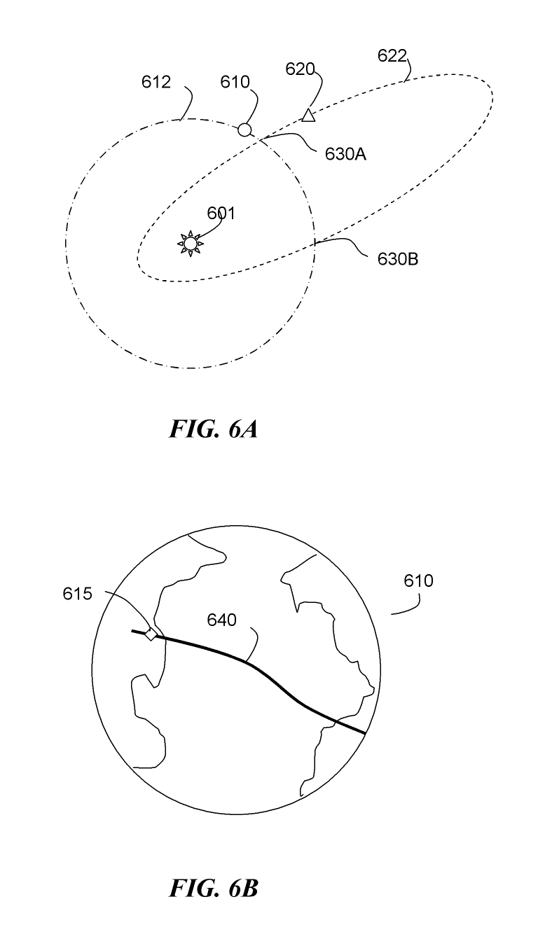

FIG. 6A illustrates planetary orbits that may be used for some embodiments of the invention. In some embodiments an asteroid impact may lift dust into the atmosphere. Planet 610 orbits the sun 601 following nearly-circular orbit 612. Asteroid 620 also orbits the sun 601 following its elliptical orbit 622. There are many asteroids in the solar system whose orbits have portions both closer to the sun than Earth as well as farther away from the sun than Earth. However, because orbits are three-dimensional, not every asteroid whose orbit has parts closer to the sun and farther from the sun crosses the line of Earth's orbit. Recent surveys have found many such asteroids. A few asteroids come very close. If such an asteroid were to cross Earth's orbit while Earth was at that location in its orbit at one of crossing points 630A and 630B, an impact and explosion may occur. The asteroid selected must be large enough and solid enough to survive passage through Earth's atmosphere. However, too large an asteroid impact would throw excessive amounts of dust into the atmosphere that could cause an undesirably-large amount of cooling. A smaller asteroid impact would have a smaller effect. An moderate-sized asteroid impact may provide an effective explosion to cool the planet. Therefore, selection of the asteroid is important, and it may be necessary to direct an asteroid to hit the planet at the source site.

The orbits of asteroids can be determined with great accuracy. Asteroid Apophis will pass close to Earth in 2029. Shortly after its discovery, it was thought that Apophis would strike Earth, but this is now deemed highly unlikely. It may be desirable to use this opportunity to direct Apophis to strike Earth. Several methods for changing asteroid orbits have been proposed, including explosions on the surface of the asteroid; gravitational towing using a heavy spacecraft or long cables; differential heating with lasers, albedo changes or heat-generating reactions; and physical pushing using an impacting spacecraft or rock. These or other methods may be used to direct an asteroid to strike Earth and, by adjusting the asteroid's orbit, choose the location for the strike. By way of example, in FIG. 6B, asteroid 620 may strike planet Earth 610 at any point on impact line 640, depending on the time of impact. Using a method for changing the orbit of an asteroid, asteroid 620 may be directed to source site 615.

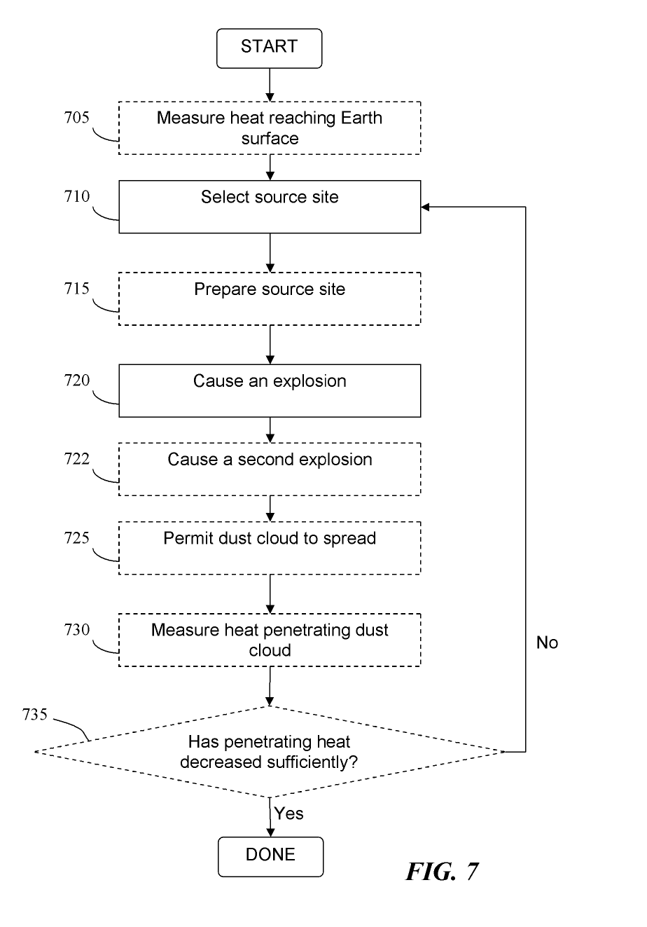

FIG. 7 is a flow diagram for a process for cooling a planet in accordance with various embodiments of the invention. At optional step 705, a measurement is made of heat at Earth's surface. This measurement may be used as a baseline comparison against which cooling will be measured. At step 710 a source site is selected. Source site may be selected based on geographical location, prevailing high-level and low-level winds, availability of suitable material for a dust cloud, distance from population centers or other criteria. At optional step 715, the ground at the source site is treated to enhance dust-generation or uplift capability. This treating may comprise removing objects from the source site that may be damaged by the explosion. Treating the site may comprise fracturing of the ground by explosives or other means, contouring or shaping the surface, or chemical treatment to modify the chemical composition of the material at the source site.

At step 720, an explosion is caused. The explosion is preferentially non-chemical, to reduce generation or carbon dioxide or other greenhouse gasses. The explosion may be nuclear or may be due to an asteroid impact at the source site. Other explosives, including chemical explosives may also be used and are considered to be within the scope of the invention. At optional step 722 a second explosion is caused to lift the dust cloud higher into the atmosphere.

At step 725 the dust cloud is permitted to spread over the target region.

Optional further steps refine the process. At step 730 a measurement is made of heat penetrating the dust cloud. The measurement may be a spectral measurement of light from the sun. The measurement may be a temperature measurement at the surface of the planet or at some representative altitude. The measurement may also be some effect of temperature, such as polar ice thickness. Other measurements are considered to be within the scope of the invention. Based on this measurement, a decision is made at step 735. If the cooling is sufficient, the process stops. If not, the process proceeds to step 710. Another explosion may be made at the same source site or at a different source site.

While many steps happen quickly, global warming is a slow process, so the time scale of the process in FIG. 7 may be on the order of months or years. It also may be on the order of minutes or seconds. All time scales are considered to be within the scope of the invention. Each explosion is representative and may actually comprise several individual simultaneous or sequential explosive events. Explosions may be the result of chemical reactions, nuclear reactions, impact of an extraterrestrial object or other means.

Accordingly, the reader will see that, an explosion at a suitable source site can cool a planet.

While the foregoing describes exemplary embodiments in accordance with one or more aspects of the present invention, other and further embodiments in accordance with the one or more aspects of the present invention may be devised without departing from the scope thereof, which is determined by the claims that follow and equivalents thereof. Claims listing steps do not imply any order of the steps. Trademarks are the property of their respective owners.

What is claimed is:

1. An apparatus for cooling a planet, comprising:
a source site; and
a first explosive located at the source site, the explosive for generating a dust cloud and for generating an updraft for lifting the dust cloud into the atmosphere.

2. An apparatus of claim 1, comprising:
a decision system coupled to the detonator of the first explosive; and
a measurement device, coupled to the decision system, the measurement device to determine the amount of light energy reaching the surface of the planet, the output of the measurement device coupled to the decision system, and wherein the decision system controls the detonation of the explosive.

3. The apparatus of claim 2, wherein the measurement device measures temperature.

4. The apparatus of claim 2, wherein the measurement device measures the spectrum of light.

5. The apparatus of claim 1, wherein the source site comprises winds blowing toward a region to be cooled.

6. The apparatus of claim 1, wherein the source site comprises a volcanic region.

7. The apparatus of claim 1, comprising:
a second explosive, positioned above the source site, the second explosive placed so that when detonated, it generates an updraft to lift the dust cloud higher into the atmosphere.

8. The apparatus of claim 7, wherein the second explosive is a nuclear explosive.

9. The apparatus of claim 1, wherein the first explosive is a nuclear explosive.

10. A method for cooling a planet, the method comprising:
selecting a source site; and
causing an explosion at the source site, the explosion generating a dust cloud, the explosion further generating an updraft to lift the dust cloud.

11. A method of claim 10, wherein the step of causing an explosion comprises detonating nuclear explosive.

12. A method of claim 11, wherein the detonating occurs no higher than 50 meters above the surface of the ground.

13. A method of claim 10, wherein the step of selecting a source site comprises selecting a site with magma under the surface.

14. A method of claim 10, wherein the step of selecting a source site comprises selecting a site at which overhead winds blow toward a target region to be cooled.

15. A method of claim 10, wherein the step of causing an explosion comprises:
deflecting an asteroid to hit the planet, wherein the explosion is caused by the impact of the asteroid.

16. A method for cooling a planet, the method comprising:
selecting a source site for an explosion;
generating a dust cloud at the source site; and
generating an updraft at the source site.

17. A method of claim 16, wherein:
generating a dust cloud comprises causing a first explosion; and
generating an updraft comprises causing a second explosion.

18. A method of claim 16, the method comprising:
measuring the amount of heat blocked as a result of the explosion; and
if the heat blocked as a result of the explosion is not sufficient, causing a second explosion.

19. A method of claim 18, wherein the measuring comprises a temperature measurement.

20. A method of claim 16, the method comprising:
waiting until high-altitude winds over the source site are of sufficient strength and direction to move the dust cloud over a target region to be cooled.
